(19) United States
(12) Patent Application Publication
(10) Pub. No.: US 2011/0146895 A1
(43) Pub. Date: Jun. 23, 2011

(54) METHOD FOR PRODUCING A FUEL TANK

(75) Inventors: Ulrich Borchert, Kranzberg (DE); Jens Skowronek, Baldham (DE)

(73) Assignee: Benteler Automobiltechnik GmbH, Paderborn (DE)

(21) Appl. No.: 12/821,521

(22) Filed: Jun. 23, 2010

(30) Foreign Application Priority Data
Jun. 23, 2009 (DE) 10 2009 030 221.2

(51) Int. Cl. B29C 65/72; B29C 65/52

(52) U.S. Cl. 156/245

(57) ABSTRACT

In a method for producing a fuel tank, an elastomer layer made of a rubber mixture is applied on an interior shell adapted to receive fuel, a fiber composite material forming a protective cover is introduced into a mold, inserting the fuel tank with the elastomer layer in the mold so as to surround the elastomer layer with the fiber composite material, the fiber composite material is adhesively bonded to the elastomer layer with a laminating resin, and the fuel tank with the protective cover is vulcanized at temperatures between 80° C. and 180° C. over a time of 2 hours to 36 hours. The fiber composite material includes a cover layer made of a gel coat having a higher flame point than the elastomer layer.

### CROSS-REFERENCES TO RELATED APPLICATIONS

This application claims the priority of German Patent Application, Serial No. 10 2009 030 221.2, filed Jun. 23, 2009, pursuant to 35 U.S.C. 119(a)-(d), the content of which is incorporated herein by reference in its entirety as if fully set forth herein.

### BACKGROUND OF THE INVENTION

The invention relates to a method for producing a fuel tank for vehicles, in particular motor vehicles.

The following discussion of related art is provided to assist the reader in understanding the advantages of the invention, and is not to be construed as an admission that this related art is prior art to this invention.

It is known to provide fuel tanks used in motor vehicles with jackets that hinder fuel leakage. Such jackets ensure that as little fuel as possible is discharged from the fuel tank after ballistic impact of a projectile or fragments, in order to prevent ignition of the vehicle underbody caused by incendiaries or other ignition sources. The intent is here to give the occupants sufficient time to remove the motor vehicle from the danger zone and to in general reduce the risk of ignition of the motor vehicle.

Series-produced tanks for motor vehicles are conventionally encased with one or more individual layers or monolayers, made of a material based on caoutchouc or a rubber compound. Certain rubber compositions swell upon contact with fuels, such as gasoline or diesel. This property can be used to seal holes.

These rubber compositions are typically applied as individual sections placed on the fuel tank, which produces overlaps and/or material joints that can cause variations in the material thickness and hence in the overall effectiveness. To provide sufficient support to the elastomer layer, a second layer, a so-called protective cover, composed of plastic or resin, is applied which can also be partially reinforced with a fabric material. The plastic or resin layer is typically applied by hand. This may disadvantageously cause irregularities on the exterior surface of such lined series-produced fuel tanks. In other words, this manufacturing technique has a relatively low process reliability. The manual manufacturing process causes unavoidable variations in the material thickness. Because the fuel tank is surrounded by various components and structures, a uniform geometry with constant material thickness is desirable.

DE 28 53 784 A1 discloses a conventional pliable, self-sealing wall where two or more layers of an elastomer are in surface-contact with one another and are joined at spaced-apart locations such that the layers can move relative to one another between these locations, enabling small holes to be closed by the mutual displacement of the layers. The employed elastomer layers are shaped into a fuel tank by connecting the cut edges of the employed material in abutting, flush arrangement, either with an adhesive or by vulcanizing.

DE 297 00 151 U1 describes a safety tank of the type used in motor vehicles and in particular in race cars. Preferably, a multipart exterior shell is produced, for example from a composite material. A prefabricated inner tank made of rubber, which is not yet vulcanized, is inserted in the exterior shell and vulcanized after the exterior shell is closed.

WO 2007/045466 A1 discloses conventional fuel tanks for motor vehicles having a multilayer structure. An interior tank is made of a thermoplastic material designed to be in contact with the fuel. An intermediate layer is made of a composite material. A cover layer is applied onto the intermediate layer. This cover layer may be a varnish or paint to protect the surfaces of the layers underneath.

It would therefore be desirable and advantageous to provide an improved method for producing a fuel tank with an elastomer layer of uniform thickness and uniform effectiveness, so that subsequently the exterior geometry of the fuel tank is as uniform as possible.

### SUMMARY OF THE INVENTION

According to an aspect of the invention, a method for producing a fuel tank includes applying an elastomer layer made of a rubber mixture on an interior shell adapted to receive fuel, introducing a fiber composite material into a mold, inserting the fuel tank with the elastomer layer in the mold so as to surround the elastomer layer with the fiber composite material as a protective layer, adhesively bonding the fiber composite material to the elastomer layer inside the mold by way of an applied laminating resin, and vulcanizing the fuel tank with the protective cover at temperatures between 80° C. and 180° C. over a time of 2 hours to 36 hours.

The fiber composite material forming a protective cover is produced by introducing into the mold a cover layer made of a gel coat based on an epoxy resin having a higher flame point than the elastomer layer, applying a bonding layer, applying a fabric layer on the bonding layer, said bonding layer bonding the fabric layer to the cover layer, and applying at least one additional fabric layer with a laminating resin.

The elastomer layer exhibits the characteristic to swell upon contact with the fuel. The elastomer layer made of the rubber mixture is homogenized during vulcanization. The long-chain rubber molecules are cross-linked by sulfur bridges under the influence of the temperature. With the method of the invention, overlaps and joints between the individual rubber layers are advantageously evened out by the vulcanization process, producing a homogeneous elastomer layer of substantially constant wall thickness. The method of the invention significantly improves the accuracy, in particular the dimensional accuracy, for repeated process cycles over non-vulcanized elastomer layers.

If the fuel tank is damaged so that fuel comes into contact with the elastomer layer, the elastomer layer swells due to the resistant interior shell and the support provided by the protective cover exclusively in the direction of the hole to be closed, thereby preventing further discharge of fuel. With the arrangement of the invention, material of the elastomer layer always reaches the region of the hole, as long as it is certain that fuel comes into contact with the elastomer. The protective cover is in the form of a fiber composite material, which due to its high strength and stiffness is suitable to adequately support the elastomer layer.

The fuel tank is produced by inserting the elastomer layer into a mold in which the fiber composite material had been previously introduced, wherein the fiber composite material is adhesively bonded with the elastomer layer inside the mold. Unlike with manual application of individual fabric layers impregnated with resin onto the previously applied elastomer layer, the use of a mold ensures that the fuel tanks enclosed in this manner all have the same outside geometry. In addition, the mold may be made of a material having high heat-resistance, such as aluminum, so that the fuel tank can still be vulcanized inside the mold after the fiber composite material has sufficiently hardened, for example after an hour. The mold may be placed into a heating furnace. The exact temperature profile inside the heating furnace depends considerably on the employed rubber mixture. Preferably, vulcanization is performed at temperatures between 80° C. and 120° C. A preferred timeframe for vulcanization is about 6 hours to about 14 hours. The vulcanizing temperatures and times are affected by three factors: a) the temperature resistance of the fuel tank to be protected, which is composed of plastic; b) the temperature absorption of the mold (heat-up phase); and c) the employed rubber mixture.

The protective jacket made of the fiber composite material is structured in several layers. The protective cover is produced by initially introducing a cover layer into the mold to produce a smooth surface. Subsequently, a bonding layer is applied to bond the cover layer to a subsequently introduced fabric layer. Subsequent to this outer fabric layer, at least one additional fabric layer is applied onto the outer fabric layer by applying a laminating resin. Finally, the produced structure is adhesively bonded to the elastomer layer attached to the interior shell by using the laminating resin. This final adhesive bonding is performed by inserting the interior shell with the elastomer layer into the mold.

For improving fire protection, a gel coat based on a epoxy resin is used as a cover layer, which due to its higher ignition point extends the time during which the elastomer layer and hence the fuel tank is resistant to fire. The flame point of the gel coat and/or the cover layer is higher than the flame point of the elastomer layer.

Advantageously, the outer fabric layer may be a glass fiber fabric. Preferably, a mixed fabric, for example a mixed fabric made of carbon fiber and aramide fiber is used for the at least one additional inner fabric layer. Particularly advantageous may be a mixed fabric containing 61% carbon fibers and 39% aramide fibers.

The bonding layer is preferably made of a laminating resin strengthened with cotton flocks.

The elastomer layer according to the present invention may be constructed in several layers in the same way as the fiber composite material may be formed in several layers. In particular, an additional elastomer layer is applied to an inner elastomer layer that is in contact with the interior shell. The second elastomer layer can be applied without the use of additional adhesives, because the elastomer layers bond to each other directly due to their adhesive forces. By taking account the fact that the bonded elastomer layers are subsequently vulcanized and hence fuse together, there is no need to employ additional adhesives.

With the method of the invention, a cover for fuel tanks resisting leakage can be produced with high reliability. This cover does not have any weak points caused by different material thicknesses due to overlaps and material joints and, in addition, has a uniform, precisely defined exterior geometry, preventing the fuel tank from colliding with adjacent components and structures during installation.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a fuel tank in a perspective view;

FIG. 2 shows the fuel tank of FIG. 1 in a partial cross-section; and

FIG. 3 shows a detail of the illustration of FIG. 2.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

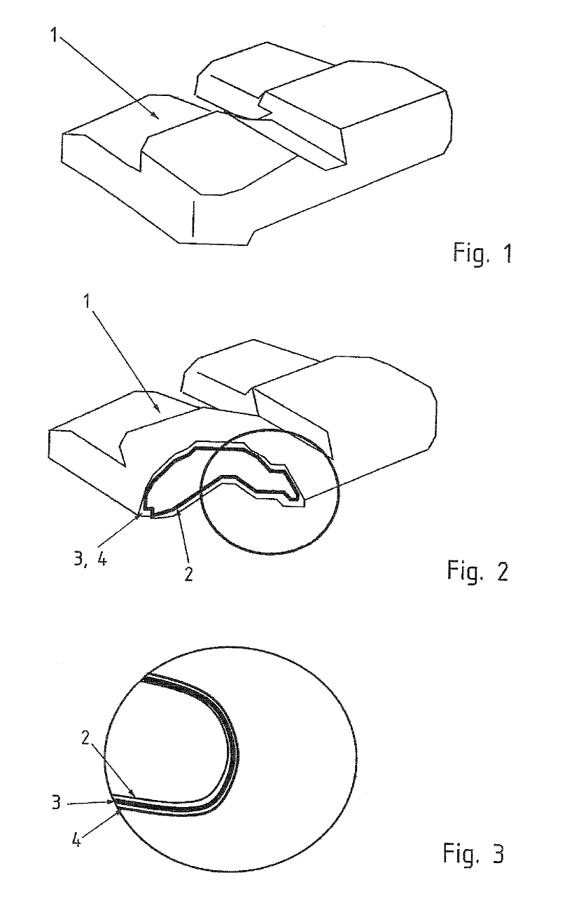

Turning now to the drawing, and in particular to FIG. 1, there is shown a fuel tank 1 of a type produced with the method of the invention as a final product. The fuel tank 1 has a complex configuration adapted to the respective vehicle geometry. The fuel tank 1 has a three-layer structure, as illustrated in FIGS. 2 and 3.

The fuel tank 1 includes initially an interior shell 2. This interior shell 2 is formed by a series-produced tank of the motor vehicle. The fuel for the motor vehicle is carried inside this interior shell 2. This interior shell 2 is surrounded by a protective sheath, which is divided into an elastomer layer 3 and a protective cover 4. FIG. 3 shows in a simplified illustration that the elastomer layer 3 is arranged between the interior shell 2 and the protective cover 4. The elastomer layer 3 is provided to close a hole in the interior shell 2, if the fuel tank 1 is damaged as a result of an impact. This is accomplished by producing the elastomer layer 3 from a rubber mixture which swells upon contact with fuel, thereby closing the hole produced by the ballistic impact.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for producing a fuel tank, comprising the steps of:
applying an elastomer layer made of a rubber mixture on an interior shell adapted to receive fuel,
introducing a fiber composite material into a mold, said fiber composite material forming a protective cover and produced by:
introducing a cover layer into the mold, said cover layer made of a gel coat based on an epoxy resin having a higher flame point than the elastomer layer,
applying a bonding layer,
applying an outer fabric layer on the bonding layer, said bonding layer bonding the fabric layer to the cover layer, and
applying at least one additional fabric layer with a laminating resin,
inserting the fuel tank with the elastomer layer in the mold so as to surround the elastomer layer with the fiber composite material,
adhesively bonding the fiber composite material to the elastomer layer inside the mold by way of the laminating resin, and
vulcanizing the fuel tank with the protective cover at temperatures between 80° C. and 180° C. over a time of 2 hours to 36 hours.

2. The method of claim 1, wherein the fuel tank is vulcanized inside the mold.

3. The method of claim 1, wherein the mold is placed into a heating oven for vulcanization.

4. The method of claim 1, wherein the outer fabric layer is made of a glass fiber fabric.

5. The method of claim 1, wherein a mixed fabric is used as at least one additional, inner fabric layer.

6. The method of claim 5, wherein the mixed fabric contains carbon fibers and aramide fibers.

7. The method of claim 1, wherein the elastomer layer comprises a plurality of layers, with at least one additional elastomer layer being applied on an inner elastomer layer which is adhesively bonded to the interior shell.

8. The method of claim 7, wherein the at least one additional elastomer layer is bonded to the inner elastomer layer without using additional adhesives.

9. The method of claim 1, wherein the cover layer is a surface resin.
